(19) United States
(12) Patent Application Publication
(10) Pub. No.: US 2026/0118941 A1
(43) Pub. Date: Apr. 30, 2026

(54) SYSTEM AND METHOD FOR REDUCED ENERGY LOGGER MODE FOR POWERED TRACKERS

(71) Applicant: Copeland Cold Chain LP, Kennesaw, GA (US)

(72) Inventors: Rodney Parsons, Jupiter, FL (US); Elkan Du, Shanghai (CN); Yu Chu Joey Wu, Delray Beach, FL (US)

(21) Appl. No.: 18/933,863

(22) Filed: Oct. 31, 2024

(51) Int. Cl. G06F 1/3234; G06F 1/3212; G06Q 10/0832; G06Q 10/0833

(52) U.S. Cl. CPC G06F 1/3234; G06F 1/3212; G06Q 10/0832; G06Q 10/0833

(57) ABSTRACT

A tracker unit for monitoring conditions including a communication module, at least one temperature sensor, a battery sensor, at least one processor, and at least one memory device, where the at least one processor is programmed to: a) operate in two modes including a regular mode and a logger mode, wherein during the regular mode, the at least one processor is programmed to: i) receive temperature readings, ii) transmit the temperature readings to a remote computer device, iii) receive battery readings, and iv) determine whether or not to enter the logger mode based upon the battery readings and the temperature readings, wherein during the logger mode the at least one processor is programmed to: i) disable the communication module, ii) receive and store temperature readings; iii) receive battery readings; and iv) determine whether or not to enter the regular mode based upon the battery readings and the temperature readings.

### FIELD

The present disclosure relates to reduced energy logger mode for powered trackers, and, more particularly, to a network-based system and method for supporting logger modes for cold alkaline powered trackers.

### BACKGROUND

Monitoring perishable goods requires critical tracking from transportation stage to distribution process to delivery to the end-users. At transportation stage, the cargo in transit relies on tracker's real-time reporting of the cargo's condition. However, when the tracker's power supply fails, it also causes the tracker to prematurely cease to operate and never recover. Alkaline battery packs exhibit deceased ability to supply higher peak currents at low temperatures and voltage levels. This causes the trackers to deactivate due to cold and thereby lose the ability track temperatures of the corresponding load in transit.

This background section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, these statements are to be read in this light, and not as admissions of prior art.

### BRIEF SUMMARY

In one aspect, a tracker unit for monitoring conditions is disclosed. The tracker unit includes a communication module capable of communicating with remote computer devices, at least one temperature sensor, a battery sensor capable of monitoring at least one attribute of a battery powering the tracker unit, at least one processor, and at least one memory device, where at least one processor in communication with the at least one memory device. The at least one processor is programmed to a) operate in two modes including a regular mode and a logger mode, wherein during the regular mode, the at least one processor is programmed to i) receive temperature readings provided by the at least one temperature sensor, ii) transmit the temperature readings to a remote computer device via the communication module, iii) receive battery readings provided by the battery sensor, and iv) determine whether or not to enter the logger mode based upon the battery readings and the temperature readings, wherein during the logger mode the at least one processor is programmed to i) disable the communication module, ii) receive and store temperature readings provided by the at least one temperature sensor, iii) receive battery readings provided by the battery sensor, and iv) determine whether or not to enter the regular mode based upon the battery readings and the temperature readings. The tracker unit may have additional, less, or alternate functionalities, including those discussed elsewhere herein.

In another aspect, a computer device for monitoring conditions is disclosed. The computer device includes at least one processor in communication with at least one memory device and in communication with a remote computer device via a communication module. The at least one processor is programmed to a) operate in two modes including a regular mode and a logger mode, wherein during the regular mode, the at least one processor is programmed to i) receive temperature readings provided by at least one temperature sensor, ii) transmit the temperature readings to the remote computer device via the communication module, iii) receive battery readings provided by a battery sensor, and iv) determine whether or not to enter the logger mode based upon the battery readings and the temperature readings, wherein during the logger mode the at least one processor is programmed to i) disable the communication module, ii) receive and store temperature readings provided by the at least one temperature sensor in the memory device, iii) receive battery readings provided by the battery sensor, and iv) determine whether or not to enter the regular mode based upon the battery readings and the temperature readings. The computer device may have additional, less, or alternate functionalities, including those discussed elsewhere herein.

Advantages will become more apparent to those skilled in the art from the following description of the embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. There are shown in the drawings arrangements which are presently discussed, it being understood, however, that the present embodiments are not limited to the precise arrangements and are instrumentalities shown.

FIG. 1 illustrates a block diagram of an example tracker unit, in accordance with at least one embodiment of the disclosure.

FIG. 2 illustrates a block diagram of a process for operating the tracker unit shown in FIG. 1 in a first mode.

FIG. 3 illustrates a block diagram of a process for operating the tracker unit shown in FIG. 1 in a second mode.

FIG. 4 illustrates an example configuration of a client computer device, in accordance with one embodiment of the present disclosure.

Corresponding reference characters indicate corresponding parts throughout the drawings.

### DETAILED DESCRIPTION

The present embodiments may relate to, inter alia, systems and methods for supporting logger modes for cold alkaline powered trackers. In one example embodiment, the methods may be performed by a tracker unit controller. The present embodiments relate to a tracker powered by an alkaline battery pack. The tracker automatically switches to a logger only mode when the ambient temperature drops to a low temperature and the output voltage of the alkaline battery pack drops below a certain value. As the critical point on a cold alkaline is approached, the tracker shifts operating mode to logging temperature only. No data is attempted to transmit wirelessly, such as over the cellular backbone. If, and when, operating conditions improve (i.e., temperature rises) and subsequently pack voltage recovers, the tracker reverts to cellular tracker mode and reports all stored temperature reports. Thus, coverage of the perishable loads continues, and the customer does not lose any data but only the immediacy of reports during this adverse time. In other embodiments, the tracker operates in RF dead zones, where operation continues but in a logging mode.

In these embodiments, the tracker shifts from the first mode to the second mode when the alkaline battery pack exhibits decreased ability to supply at low temperatures and voltage levels. Then the tracker shifts back from the second mode to the first mode when temperature rises and the alkaline battery pack voltage recovers. The different modes of the tracker save all data by preventing premature ceasing of the tracker when output voltage of the alkaline battery pack drops below a certain level. This is especially important when the tracker is tracking a cargo that contains items that are temperature sensitive, such as perishable products, which need to be kept below a specific temperature. By ensuring that all measurements are taken and saved, even when conditions are averse to the tracker, the tracking unit can show the conditions that the cargo endured.

At least one of the technical solutions to the technical problems provided by this system may include: (i) maintaining continuous monitoring in adverse conditions; (ii) maintaining continuous monitoring during low battery conditions; (iii) maintaining continuous monitoring in radio-frequency dead zones; and/or (iv) improved accuracy of monitoring.

The methods and systems described herein may be implemented using computer programming or engineering techniques including computer software, firmware, hardware, or any combination or subset thereof, wherein the technical effects may be achieved by performing at least one of the following steps: a) operate in two modes including a regular mode and a logger mode, during the regular mode, i) receive temperature readings provided by the at least one temperature sensor; ii) transmit the temperature readings to a remote computer device via the communication module; iii) receive battery readings provided by the battery sensor; and iv) determine whether or not to enter the logger mode based upon the battery readings and the temperature readings; b) during the logger mode i) disable the communication module; ii) receive and store temperature readings provided by the at least one temperature sensor; iii) receive battery readings provided by the battery sensor; and iv) determine whether or not to enter the regular mode based upon the battery readings and the temperature readings; c) during the regular mode i) receive location readings from the location module; and ii) transmit the location readings along with the temperature readings to a remote computer device via the communication module; d) during the logger mode disable the location module; e) during a transition from logger mode to regular mode i) reactivate the communication module; and ii) transmit temperature readings taken during the logger mode; f) during a transition from logger mode to regular mode transmit all of the temperature readings taken in both logger mode and regular mode; g) during the regular mode store all received temperature readings; h) compare the temperature readings and the battery readings to one or more predetermined thresholds to determine whether or not to change modes; i) a predetermined threshold for the battery to transition to the logger mode is different than the predetermined threshold for the battery to transition from the logger mode; j) a predetermined threshold for temperature to transition to the logger mode is different than the predetermined threshold for temperature to transition from the logger mode; k) the battery readings include a current voltage of the battery; l) the battery is at least one of an alkaline battery and an alkaline battery pack; m) the tracker unit is tracking a load of perishable goods; n) during the regular mode determine that the tracker unit is within a RF (radio frequency) dead zone; during the regular mode transition to logger mode while the tracker unit remains in the RF dead zone; and the communication module is capable of cellular communication.

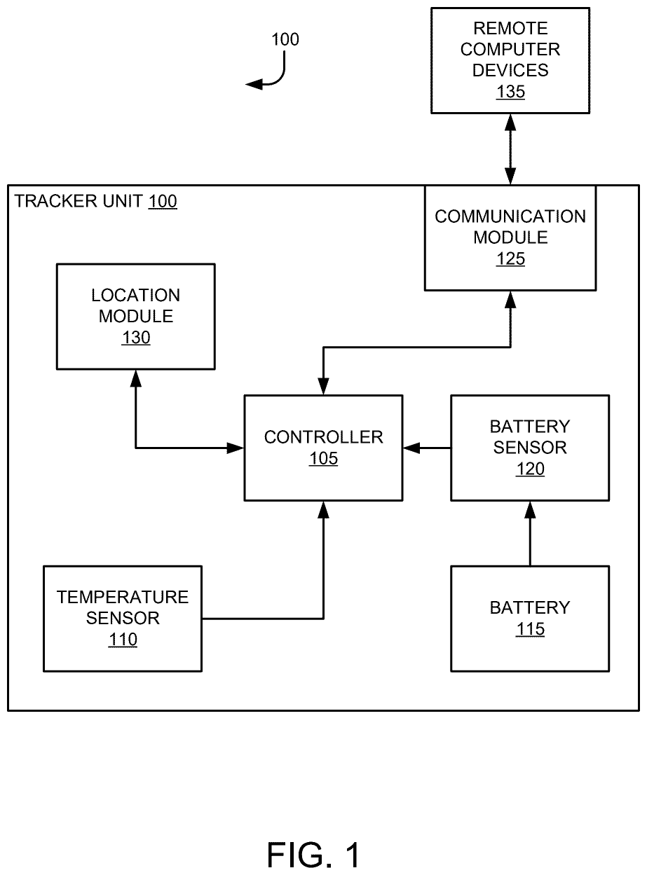

FIG. 1 illustrates a block diagram of an example tracker unit 100, in accordance with at least one embodiment of the disclosure. The tracker unit 100 is configured for monitoring conditions of a load in transit, as well as provide the current location of the load.

The tracker unit 100 includes a controller 105 that controls the operation of the tracker unit 100. The controller 105 is in communication with at least one temperature sensor 110 that measure the current temperature. In some embodiments, the temperature sensor 110 monitors the current temperature of the air around the tracker unit 100. In other embodiments, the temperature sensor 110 includes one or more probes that measure the temperature at specific locations. In some further embodiments, there are multiple temperature sensors 110 connected to the controller 105. In other embodiments, the controller 105 may be in communication with other types of sensors, such as, but not limited to, humidity, orientation, altitude, accelerometer, light, and/or any other type of sensor desired. In some embodiments, the controller 105 polls the temperature sensor 110 on a periodic basis to determine the current temperature.

The tracker unit 100 also includes at least one battery 115 to power the tracker unit 100 and its operations. In the example embodiment, the battery 115 is an alkaline battery or alkaline battery pack. The battery 115 may be other types of batteries that work as described herein. The controller 105 is in communication with at least one battery sensor 120 that monitors the battery 115. In the example embodiment, battery sensor 120 reports the current voltage of the battery 115 to the controller 105. The battery sensor 120 may also report other attributes of the battery 115, such as, but not limited to, amperage, internal resistance, temperature, and/or any other attribute that the user desires. In some embodiments, the controller 105 polls the battery sensor 120 on a periodic basis to determine the current battery status.

The tracker unit 100 includes a communication module 125 to communicate with one or more remote computer devices 135. The communication module 125 may allow for wireless or wired communication. Furthermore, the communication module 125 may be communicatively coupled to the Internet through many interfaces including, but not limited to, at least one of a network, such as the Internet, a local area network (LAN), a wide area network (WAN), or an integrated services digital network (ISDN), Wi-Fi connection, a cellular phone connection, and a cable modem.

The tracker unit 100 also includes a location module 130 that allows the controller 105 to determine the current location of the tracker unit 100. The location module 130 may use a global positioning system (GPS), other global navigation satellite system (GNSS), or any other positioning system to determine the current location of the location module 130 and therefore the tracker unit 100. In some embodiments, the controller 105 polls the location module 130 on a periodic basis to determine the current location.

In the example embodiment, the controller 105 periodically polls the temperature sensor 110 to get the current temperature. Then the controller 105 polls the location module 130 to determine the current location. The controller 105 then uses the communication module 125 to report the current temperature and the current location of the tracker unit 100. The information is transmitted to one or more remote computer devices 135.

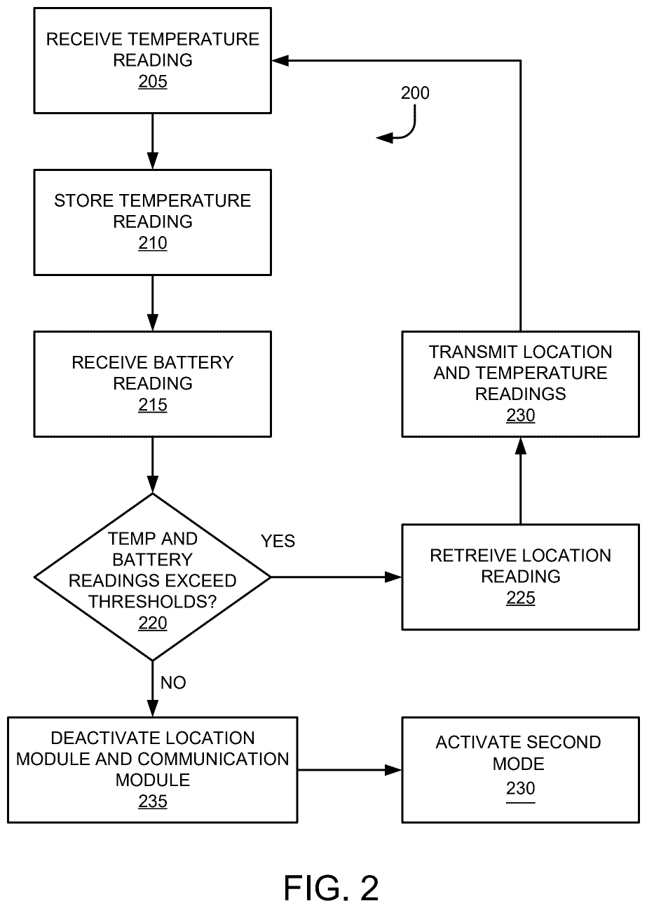

FIG. 2 illustrates a block diagram of a process 200 for operating the tracker unit 100 (shown in FIG. 1) in a first mode. In the example embodiment, the steps of process 200 are performed by the controller 105 (shown in FIG. 1) of the tracker unit 100.

In the example embodiment, the controller 105 receives 205 a temperature reading, such as from the temperature sensor 110 (shown in FIG. 1). In some embodiments, the temperature sensor 110 transmits the current temperature constantly to the controller 105. In other embodiments, the temperature sensor 110 transmits the current temperature periodically to the controller 105. In still further embodiments, the controller 105 requests the temperature sensor 110 to send the current temperature.

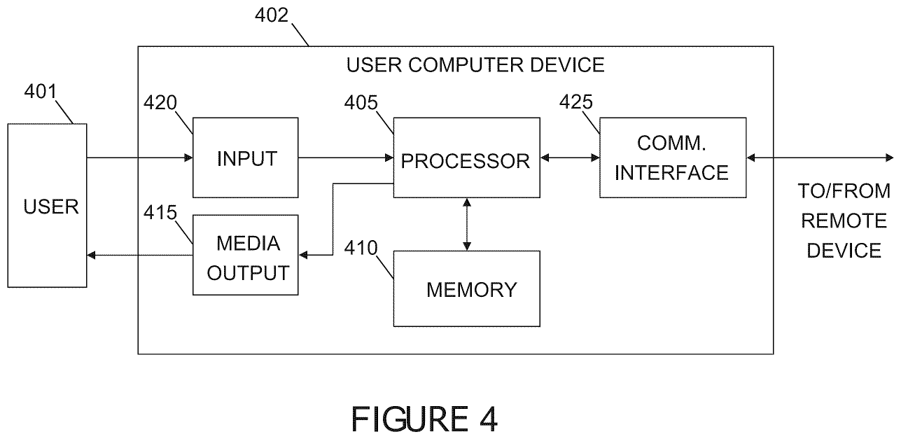

In the example embodiment, the controller 105 stores 210 the temperature reading in a memory, such as memory 410 (shown in FIG. 4). In some embodiments, the controller 105 also stores other information in the memory 410, such as the current time or other sensor information.

In the example embodiment, the controller 105 receives 215 a battery reading from the battery sensor 120 (shown in FIG. 1) of the current status of the battery 115 (shown in FIG. 1). In the example embodiment, the battery reading includes the current voltage of the battery 115.

In the example embodiment, the controller 105 compares the temperature reading and the battery reading to determine if either of them exceeds 220 one or more predetermined thresholds. In one embodiment, the temperature threshold is 0 degrees C. (Centigrade). In another embodiment, the temperature threshold is negative 20 degrees C. In a further embodiment, the voltage threshold is 3.5 V. These thresholds may be different values based on different situations. If the battery reading exceeds its threshold and the temperature reading exceeds its threshold, then the controller 105 proceeds to step 225.

In the example embodiment, if both thresholds are exceeded, then the controller 105 retrieves 225 a location reading from the location module 130 (shown in FIG. 1). The controller 105 transmits 230 the location reading and the temperature reading to one or more external computer systems using the communication module 125 (shown in FIG. 1).

Then the controller 105 continues to step 205. Steps 205 through 230 form a first loop that represents a first mode (also known as a regular mode) for operation of the tracker unit 100 and its controller 105. This first mode is normal operation for the tracker unit 100 and controller 105. This loop continues until at least one of the thresholds is no longer exceeded, either the temperature reading does not exceed its predetermined threshold and/or the battery reading does not exceed its predetermined threshold. If either or both of those conditions occur, then the controller 105 proceeds to step 235.

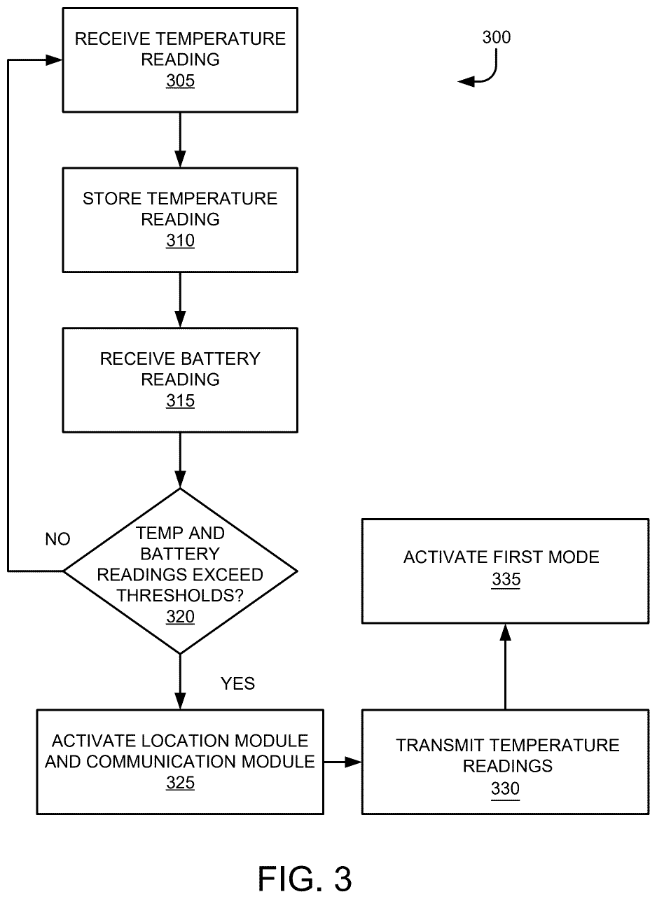

In the example embodiment, if one of the thresholds is not exceeded, the controller 105 deactivates 235 the location module 130 and the communication module 125 to conserve power. In some embodiments, the location module 130 and/or the communication module 125 are put into a sleep or low power state. Then the controller 105 activates 240 the second mode (also known as the logger mode) as described in process 300 (shown in FIG. 3).

In some embodiments, the processes 200 and 300 have differing thresholds for different conditions. For example, the battery voltage threshold is different for different temperatures. Furthermore, the temperature and battery threshold values are for example purposes, and other values may be used for other conditions, types of battery packs, and/or other device and module combinations.

FIG. 3 illustrates a block diagram of a further process 300 for operating the tracker unit shown in FIG. 1 in a second mode. In the example embodiment, the steps of process 300 are performed by the controller 105 (shown in FIG. 1) of the tracker unit 100. In some embodiments, process 300 begins after step 240 (shown in FIG. 2).

In the example embodiment, the controller 105 receives 305 a temperature reading, such as from the temperature sensor 110 (shown in FIG. 1). In some embodiments, the temperature sensor 110 transmits the current temperature constantly to the controller 105. In other embodiments, the temperature sensor 110 transmits the current temperature periodically to the controller 105. In still further embodiments, the controller 105 requests the temperature sensor 110 to send the current temperature. In some embodiments, the controller 105 and/or the temperature sensor 110 reduce the number of readings by increasing the time between readings. For example, in the first mode (also known as the regular mode) shown in process 200, the temperature reading is taken once a minute. Then in the second mode (also known as the logger mode), the temperature reading is taken once every five minutes to reduce power consumption.

In the example embodiment, the controller 105 stores 310 the temperature reading in a memory, such as memory 410 (shown in FIG. 4). In some embodiments, the controller 105 also stores other information in the memory 410, such as the current time or other sensor information.

In the example embodiment, the controller 105 receives 315 a battery reading from the battery sensor 120 (shown in FIG. 1) of the current status of the battery 115 (shown in FIG. 1). In the example embodiment, the battery reading includes the current voltage of the battery 115.

In the example embodiment, the controller 105 compares the temperature reading and the battery reading to determine if both of them exceeds 320 one or more predetermined thresholds. In one embodiment, the temperature threshold is negative 20 degrees C. In another embodiment, the temperature threshold is 0 degrees C. In a further embodiment, the temperature threshold is 10 degrees C. In other embodiments, the voltage threshold is 3.5 V. These thresholds may be different values based on different situations, such as, but not limited to, different types of batteries.

In at least one embodiment, the temperature threshold for Step 220 in process 200 (shown in FIG. 2) is different than or less than the temperature threshold for Step 320 in process 300. For example, the temperature threshold to transition to the second mode is below 0 degrees C. and the temperature threshold to transition back to the first mode it above 10 degrees C. The same holds true for the voltage thresholds, such that the voltage threshold to transition to the second mode is below 3.5 V and the temperature threshold to transition back to the first mode is above 3.6 V. One having skill in the art would understand that these threshold values are for illustrative purposes only.

If neither the battery reading exceeds its threshold nor the temperature reading exceeds its threshold, then the controller 105 proceeds to step 305. Steps 305 through 320 form a second loop that represents a second mode for operation of the tracker unit 100 and its controller 105. This first mode is normal operation for the tracker unit 100 and controller 105. The second mode is a logger mode for the tracker unit 100. This loop continues until both of the thresholds are exceeded. Where the temperature reading exceeds its predetermined threshold and the battery reading exceeds its predetermined threshold. If both of those conditions do not occur, then the controller 105 proceeds to step 325.

In some further embodiments, the battery reading and the temperature reading need to exceed their respective thresholds for a period of time before the transition to the first mode. For example, the battery reading and the temperature reading need to exceed their respective thresholds for more than a minute before the transition to the first mode. If either of the readings no longer exceed their respective threshold before that minute has passed, then the controller 105 continues in the second loop until both thresholds are exceeded or met for the determined amount of time.

In the example embodiment, the controller 105 activates 325 the location module 130 and the communication module 125. Then the controller 105 transmits 330 the temperature readings to the remote computer devices 135 (shown in FIG. 1). In some embodiments, the controller 105 transmits 330 the temperature readings taken since the first mode was last active. In other embodiments, the controller 105 transmits 330 all of the temperature readings in the memory 410. Then the controller 105 activates 335 the first mode as described in process 200 (shown in FIG. 2).

In some embodiments, where the battery voltage does not recover, the temperature readings may be downloaded from the memory 410 of the tracker unit 100 through a direct, wired connection, such as a USB (universal serial bus) connection.

In some embodiments, the processes 200 and 300 have differing thresholds for different conditions. For example, the battery voltage threshold is different for different temperatures. Furthermore, the temperature and battery threshold values are for example purposes, and other values may be used for other conditions, types of battery packs, and/or other device and module combinations.

In the example embodiment, a tracker unit 100 for monitoring conditions is disclosed. The tracker unit 100 includes a communication module 125 capable of communicating with remote computer devices 135. The tracker unit 100 includes at least one temperature sensor 110. The tracker unit 100 also includes a battery sensor 120 capable of monitoring at least one attribute of a battery 115 powering the tracker unit 100. The tracker unit 100 further includes at least one processor 405 (shown in FIG. 4) and at least one memory device 410. The least one processor 405 is in communication with the at least one memory device 410.

In the example embodiment, the at least one processor 405 is programmed to operate in two modes including a regular mode and a logger mode. During the regular mode, the at least one processor 405 is programmed to receive temperature readings provided by the at least one temperature sensor 110. The at least one processor 405 is also programmed to transmit the temperature readings to a remote computer device 135 via the communication module 125. The at least one processor 405 is further programmed to receive battery readings provided by the battery sensor 120. Additionally, the at least one processor 405 is programmed to determine whether or not to enter the logger mode based upon the battery readings and the temperature readings.

During the logger mode the at least one processor 405 is programmed to disable the communication module 125. The at least one processor 405 is also programmed to receive and store temperature readings provided by the at least one temperature sensor 110. The at least one processor 405 is also programmed to receive battery readings provided by the battery sensor 120. The at least one processor 405 is further programmed to determine whether or not to enter the regular mode based upon the battery readings and the temperature readings.

In further embodiments, the tracker unit 100 also includes a location module 130. During the regular mode, the at least one processor 405 is programmed to receive location readings from the location module 130. The at least one processor 405 is also programmed to transmit the location readings along with the temperature readings to a remote computer device 135 via the communication module 125. During the logger mode, the at least one processor 405 is programmed to disable the location module 130.

In further embodiments, during a transition from logger mode to regular mode, the at least one processor 405 is programmed to reactivate the communication module 125 and transmit temperature readings taken during the logger mode. In some embodiments, during a transition from logger mode to regular mode, the at least one processor 405 is programmed to transmit all of the temperature readings taken in both logger mode and regular mode.

In further embodiments, during the regular mode, the at least one processor 405 is programmed to store all received temperature readings.

In further embodiments, the at least one processor is programmed to compare the temperature readings and the battery readings to one or more predetermined thresholds to determine whether or not to change modes. In some embodiments, the predetermined threshold for the battery to transition to the logger mode is different than the predetermined threshold for the battery to transition from the logger mode. In other embodiments, the predetermined threshold for temperature to transition to the logger mode is different than the predetermined threshold for temperature to transition from the logger mode.

In further embodiments, the battery readings include a current voltage of the battery.

In further embodiments, the battery is at least one of an alkaline battery and an alkaline battery pack.

In further embodiments, the tracker unit is tracking a load of perishable goods.

In further embodiments, during the regular mode, the at least one processor 405 is programmed to determine that the tracker unit 100 is within a RF (radio frequency) dead zone. The at least one processor 405 is also programmed to transition to logger mode while the tracker unit 100 remains in the RF dead zone.

In further embodiments, the communication module 125 is capable of cellular communication.

FIG. 4 depicts an example configuration of a client computer device, in accordance with one embodiment of the present disclosure. User computer device 402 may be operated by a user 401. User computer device 402 may include, but is not limited to, tracker unit 100 and controller 105 (both shown in FIG. 1). User computer device 402 may include a processor 405 for executing instructions. In some embodiments, executable instructions may be stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

Media output component 415 may be configured to present a graphical user interface (e.g., a web browser and/or a client application) to user 401. A graphical user interface may include, for example, an interface for viewing location information. In some embodiments, user computer device 402 may include an input device 420 for receiving input from user 401. User 401 may use input device 420 to, without limitation, to provide location information.

Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as remote computer devices. Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from controller 105. A client application may allow user 401 to interact with, for example, controller 105. For example, instructions may be stored by a cloud service, and the output of the execution of the instructions sent to the media output component 415.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A tracker unit for monitoring conditions comprising:
a communication module capable of communicating with remote computer devices;
at least one temperature sensor;
a battery sensor capable of monitoring at least one attribute of a battery powering the tracker unit;
at least one processor; and
at least one memory device, wherein at least one processor in communication with the at least one memory device, wherein the at least one processor is programmed to:
operate in two modes including a regular mode and a logger mode, wherein during the regular mode, the at least one processor is programmed to:
receive temperature readings provided by the at least one temperature sensor;
transmit the temperature readings to a remote computer device via the communication module;
receive battery readings provided by the battery sensor; and
determine whether or not to enter the logger mode based upon the battery readings and the temperature readings,
wherein during the logger mode the at least one processor is programmed to:
disable the communication module;
receive and store temperature readings provided by the at least one temperature sensor;
receive battery readings provided by the battery sensor; and
determine whether or not to enter the regular mode based upon the battery readings and the temperature readings.

2. The tracker unit of claim 1, further comprising a location module, wherein during the regular mode, the at least one processor is programmed to:
receive location readings from the location module; and
transmit the location readings along with the temperature readings to a remote computer device via the communication module.

3. The tracker unit of claim 2, wherein during the logger mode the at least one processor is programmed to disable the location module.

4. The tracker unit of claim 1, wherein during a transition from logger mode to regular mode, the at least one processor is programmed to:
reactivate the communication module; and
transmit temperature readings taken during the logger mode.

5. The tracker unit of claim 4, wherein during a transition from logger mode to regular mode, the at least one processor is programmed to transmit all of the temperature readings taken in both logger mode and regular mode.

6. The tracker unit of claim 1, wherein during the regular mode, the at least one processor is programmed to store all received temperature readings.

7. The tracker unit of claim 1, wherein the at least one processor is programmed to compare the temperature readings and the battery readings to one or more predetermined thresholds to determine whether or not to change modes.

8. The tracker unit of claim 7, wherein a predetermined threshold for the battery to transition to the logger mode is different than the predetermined threshold for the battery to transition from the logger mode.

9. The tracker unit of claim 7, wherein a predetermined threshold for temperature to transition to the logger mode is different than the predetermined threshold for temperature to transition from the logger mode.

10. The tracker unit of claim 1, wherein the battery readings include a current voltage of the battery.

11. The tracker unit of claim 1, wherein the battery is at least one of an alkaline battery and an alkaline battery pack.

12. The tracker unit of claim 1, wherein the tracker unit is tracking a load of perishable goods.

13. The tracker unit of claim 1, wherein during the regular mode, the at least one processor is programmed to:
determine that the tracker unit is within a RF (radio frequency) dead zone; and
transition to logger mode while the tracker unit remains in the RF dead zone.

14. The tracker unit of claim 1, wherein the communication module is capable of cellular communication.

15. A computer device for monitoring conditions comprising at least one processor in communication with at least one memory device and in communication with a remote computer device via a communication module, wherein the at least one processor is programmed to:
operate in two modes including a regular mode and a logger mode, wherein during the regular mode, the at least one processor is programmed to:
receive temperature readings provided by at least one temperature sensor;
transmit the temperature readings to the remote computer device via the communication module;
receive battery readings provided by a battery sensor; and
determine whether or not to enter the logger mode based upon the battery readings and the temperature readings,
wherein during the logger mode the at least one processor is programmed to:
disable the communication module;
receive and store temperature readings provided by the at least one temperature sensor in the memory device;
receive battery readings provided by the battery sensor; and
determine whether or not to enter the regular mode based upon the battery readings and the temperature readings.

16. The computer device of claim 15, further comprising a location module, wherein during the regular mode, the at least one processor is programmed to:
receive location readings from the location module; and
transmit the location readings along with the temperature readings to a remote computer device via the communication module, wherein during the logger mode the at least one processor is programmed to disable the location module.

17. The computer device of claim 15, wherein during a transition from logger mode to regular mode, the at least one processor is programmed to:
reactivate the communication module; and
transmit temperature readings taken during the logger mode.

18. The computer device of claim 15, wherein the at least one processor is programmed to compare the temperature readings and the battery readings to one or more predetermined thresholds to determine whether or not to change modes.

19. The computer device of claim 15, wherein the battery sensor monitors at least one attribute of a battery.

20. The computer device of claim 15, wherein the battery readings include a current voltage of a battery.
